(19) United States
(12) Patent Application Publication
(10) Pub. No.: US 2026/0246877 A1
(43) Pub. Date: Aug. 20, 2026

(54) IMAGE FORMING APPARATUS, METHOD OF CONTROLLING IMAGE FORMING APPARATUS, AND RECORDING MEDIUM

(71) Applicant: CANON KABUSHIKI KAISHA, Tokyo (JP)

(72) Inventor: KENTARO TAKAHASHI, Tokyo (JP)

(21) Appl. No.: 19/531,514

(22) Filed: Feb. 5, 2026

(30) Foreign Application Priority Data
Feb. 14, 2025 (JP) 2025-022439

(51) Int. Cl. H04N 1/00

(52) U.S. Cl. CPC H04N 1/00485; H04N 1/00498; H04N 1/00503; H04N 2201/0091

(57) ABSTRACT

An image forming apparatus includes an execution unit that executes a function, an acceptance unit that accepts a setting regarding the function, a display unit that displays a screen for executing the function, the screen corresponding to the accepted setting, and a print unit that prints a document including an image illustrating the screen corresponding to the accepted setting and a method of operating the image forming apparatus to execute the function.

### BACKGROUND

### Field of the Technology

The present disclosure relates to an image forming apparatus, a method of controlling the image forming apparatus, and a recording medium.

### Description of the Related Art

Japanese Patent Application Laid-Open No. 2007-114298 describes a technique that makes it possible to, in a case where an error occurs due to occurrence of a paper jam in an image processing apparatus, print a procedure manual including an image that illustrates an operation procedure and an operation method for eliminating the error.

In a case where a user performs an operation for executing a function of an image forming apparatus and a screen to be displayed changes depending on a set value, it is favorable that an operation procedure be described in a procedure manual by using a screen corresponding to a set value.

The technique described in Japanese Patent Application Laid-Open No. 2007-114298 is a technique of creating a procedure manual that describes a predetermined operation procedure when a condition that a paper jam has occurred is satisfied. Hence, a situation arises where an image illustrating a screen in the procedure manual is a fixed image regardless of the set value, and an operation screen and the image illustrating the screen in the procedure manual are different from each other, resulting in an issue that a user finds it difficult to understand which operation should be performed.

### SUMMARY

According to an aspect of the present disclosure, an image forming apparatus includes an execution unit configured to execute a function, an acceptance unit configured to accept a setting regarding the function, a display unit configured to display a screen for executing the function, the screen corresponding to the accepted setting, and a print unit configured to print a document including an image illustrating the screen corresponding

to the accepted setting and a method of operating the image forming apparatus to execute the function.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a hardware configuration of an image processing apparatus.

FIG. 2 is a diagram illustrating an example of a software configuration of the image processing apparatus.

FIG. 3 is a diagram illustrating an example of a software configuration for the image processing apparatus to execute functions.

FIGS. 4A to 4G are views each illustrating an example of a screen displayed by the image processing apparatus.

FIG. 5 is a view illustrating an example of a procedure manual printed by the image processing apparatus according to a first embodiment.

FIG. 6 is a view illustrating an example of a procedure manual printed by the image processing apparatus according to a third embodiment.

FIG. 7 is a view illustrating an example of a procedure manual printed by the image processing apparatus according to a fourth embodiment.

FIGS. 8A to 8D are views each illustrating an example of a screen displayed by the image processing apparatus according to the first to fourth embodiments.

FIG. 9A is a view illustrating an example of an operation panel of the image processing apparatus according to the second embodiment. FIG. 9B is a view illustrating an example of a screen displayed on a display of the image processing apparatus according to the second embodiment.

FIGS. 10A and 10B are flowcharts illustrating processing executed by the image processing apparatus to create print data for an operation procedure according to the first embodiment.

FIG. 11 is a view illustrating an example of a database managed by the image processing apparatus according to the first embodiment.

FIG. 12 is a flowchart illustrating an example of processing executed by the image processing apparatus to create print data for an operation procedure according to the second embodiment.

FIG. 13 is a flowchart illustrating an example of processing executed by the image processing apparatus to create print data for an operation procedure according to the third embodiment.

FIG. 14 is a flowchart illustrating an example of processing executed by the image processing apparatus to create print data for an operation procedure according to the fourth embodiment.

### DESCRIPTION OF THE EMBODIMENTS

Modes for implementing the present disclosure will be described below with reference to drawings. The scope of the present disclosure is not limited to configurations described in embodiments. Modification, such as replacement of a part of each configuration or part of processing with equivalents or omission of a part of each configuration or part of processing, may be made within a scope in which a similar effect can be obtained. Each button and each region to be described below are examples of objects.

### First Embodiment

Hardware and system configurations of an image processing apparatus 100 according to the present disclosure will now be described. The image processing apparatus 100 is, for example, also an image forming apparatus such as a multi-function peripheral, a printer, or a print apparatus.

As used herein, CPU isa central processing unit, ROM is a read only memory, and RAM is a random access memory. HDD is a hard disk drive, SSD is a solid state drive, LAN is a local area network, and USB is a universal serial bus.

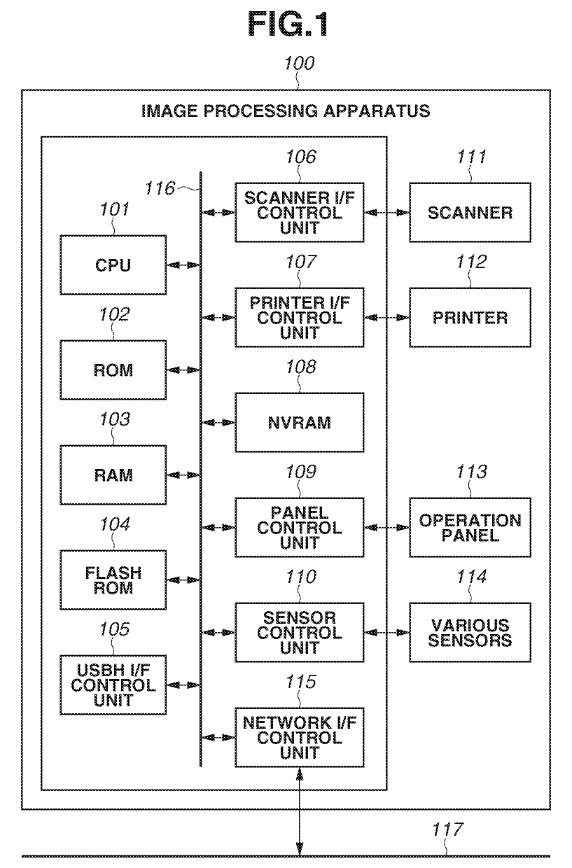

FIG. 1 is a block diagram illustrating an example of a hardware configuration of the image processing apparatus 100 according to a first embodiment.

A CPU 101 executes a software program for the image processing apparatus 100, and performs control of the image processing apparatus 100. A boot program for the image processing apparatus 100, fixed parameters, and the like are stored in a ROM 102.

A RAM 103 is used by the CPU 101 for temporary loading of data, recording of data, and the like when the CPU 101 controls the image processing apparatus 100.

A flash ROM 104 is a rewritable non-volatile memory, and an example of a storage medium (storage unit) used for saving various types of data such as storage of an installed application, application data, and print data. The storage medium may be a storage medium such as an HDD or an SSD.

A USBH interface (I/F) control unit 105 is an interface for controlling a USB host interface, and controls communication with various types of USB devices

A scanner I/F control unit 106 is a device that controls a scanner 111. A printer I/F control unit 107 is a device that controls a printer 112.

An NVRAM 108 is a non-volatile memory and is used for storing various types of setting values of the image processing apparatus 100.

A panel control unit 109 controls an operation panel 113 to display various types of information on the operation panel 113, and connects the CPU 101 and the operation panel 113 and mediates transmission of information between the CPU 101 and the operation panel 113 to enable the CPU 101 to receive input of an instruction from a user.

A sensor control unit 110 is a device that controls various sensors 114 included in the image processing apparatus 100.

Examples of the various sensors 114 include a human presence sensor that determines whether a human is present in the vicinity of the image processing apparatus 100.

A network I/F control unit 115 controls transmission and reception of data between the image processing apparatus 100 and an external apparatus connected to a LAN network 117 via the LAN network 117.

A bus 116 is a system bus that is used for transmission and reception of control signals from the CPU 101 and data signals between various devices. The bus 116 communicably connects the CPU 101, the ROM 102, the RAM 103, and the flash ROM 104. The USBH I/F control unit 105, the scanner I/F control unit 106, the printer I/F control unit 107, the NVRAM 108, the panel control unit 109, the sensor control unit 110, and the network I/F control unit 115 are connected to the bus 116, and can communicate with each other.

The scanner 111 is a device that reads a document on a reading unit (platen glass) and converts the document into data.

The printer 112 is used to print an image based on the image data on, for example, a print medium such as paper.

The operation panel 113 is a display unit such as a liquid crystal display or a touch panel, and displays various setting screens, input screens, and the like of the image processing apparatus 100 to a user. Additionally, the operation panel 113 includes buttons and keys. By operating the operation panel 113, the user can operate the image processing apparatus 100.

The CPU 101 executes a program and can thereby function as various types of units. A control circuit such as an application-specific integrated circuit (ASIC) that operates in coordination with the CPU 101 may function as such units. These units may be implemented by coordination between the CPU 101 and a control circuit that controls the operation of the image processing apparatus 100.

The CPU 101 is not necessarily a single unit, and there may be a plurality of CPUs 101. In this case, the plurality of CPUs 101 executes distributed processing. The plurality of CPUs 101 may be disposed in a single computer, or may be disposed in a plurality of physically different computers. The units implemented by execution of the program by the CPU 101 may be implemented by a dedicated circuit.

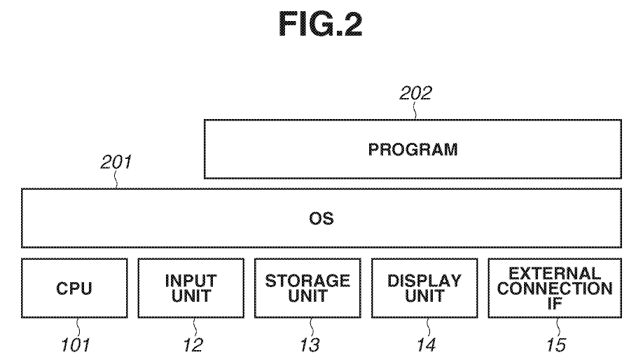

FIG. 2 is a diagram illustrating an example of the system configuration of the image processing apparatus 100. Each unit is controlled by the CPU 101 to implement each function.

An operating system 201 (hereinafter referred to as the OS 201) is software that serves as a platform for the system. A program 202 is software that operates on the OS 201. Each function of the OS 201 and the program 202 is implemented by processing executed by the CPU 101 of the image processing apparatus 100. An input unit 12 corresponds to the scanner I/F control unit 106, the printer I/F control unit 107, and the sensor control unit 110. A storage unit 13 corresponds to the ROM 102, the RAM 103, the flash ROM 104, and the NVRAM 108.

A display unit 14 corresponds to the panel control unit 109, and an external connection IF 15 corresponds to the network I/F control unit 115.

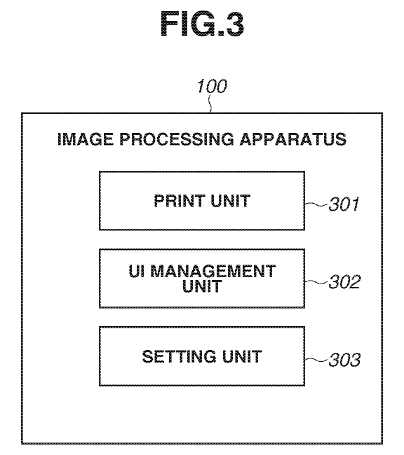

FIG. 3 illustrates a configuration example of functions included in the image processing apparatus 100. The image processing apparatus 100 includes a print unit 301 that executes print, a user interface (UI) management unit 302 that manages displaying a screen, and a setting unit 303 that manages various types of settings. Examples of the settings include a network setting, a sleep setting, a print paper setting, and a monochrome/color setting in the image processing apparatus 100. Each unit is controlled by the CPU 101 to implement each function.

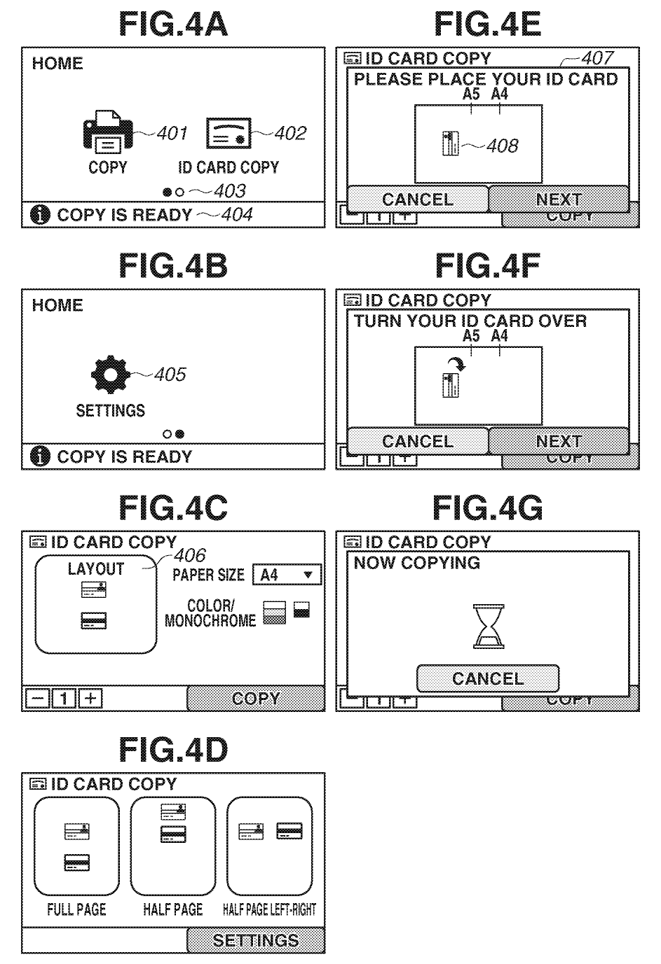

FIGS. 4A to 4D each illustrate an example of a screen displayed by the image processing apparatus 100. FIG. 4A illustrates an example of a home screen of the image processing apparatus 100. An icon 401 for a copy function and an icon 402 for an ID card copy function are displayed on the home screen.

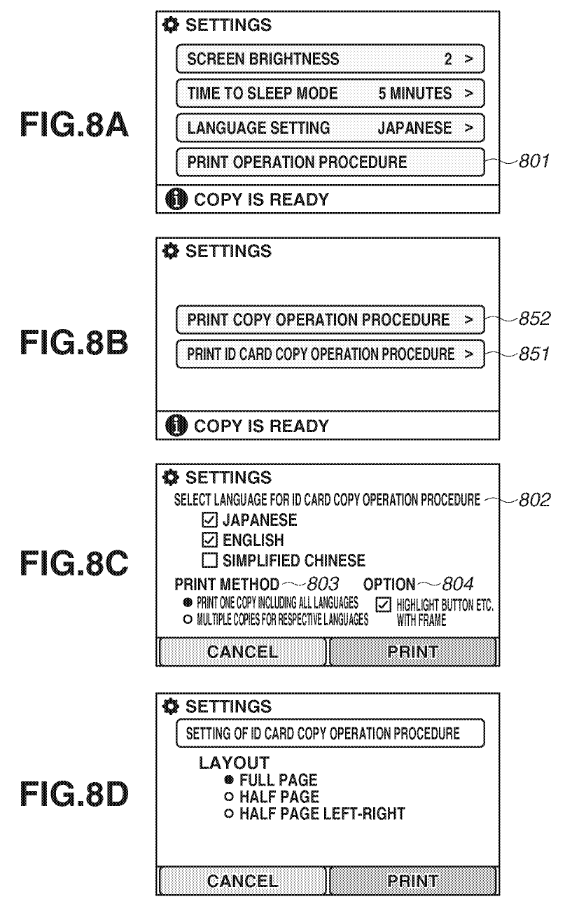

An icon 403 is an icon for selecting a page on the home screen. The number of circle icons indicates the number of screens, and a black circle icon indicates a screen (page) being displayed on the home screen. When the user touches an icon corresponding to the second page in the icon 403, a screen illustrated in FIG. 4B is displayed, which includes an icon 405 for displaying a setting screen that enables setting functions. When the icon 405 is selected, the setting screen in FIG. 8A is displayed on the operation panel 113. A region 404 is a region that provides notification about a state of the image processing apparatus 100. In the example in FIG. 4A, a text string indicating that the image processing apparatus 100 can execute copy is displayed.

In addition to the icons 401 and 402, an icon (not illustrated) corresponding to a function executable by the image processing apparatus 100 is displayed on the home screen. The number of screens (pages) of the home screen is freely selected.

The image processing apparatus 100 includes a display having a touch function in many cases. It is common that the screens illustrated in FIGS. 4A-4G are displayed.

An ID card copy function (icon 402) is one of frequently used functions. For example, this function is used when a student copies a student identification card in a public facility such as a college, and a guest copies an ID card using an image processing apparatus installed in a hotel at the time of check-in.

With the ID card copy function, the user needs to place the ID card on the scanner 111 so that the front surface faces a reading unit. The ID card is then turned over and placed on the scanner 111 again.

Regarding a procedure for this operation, an example of a screen to be displayed on the operation panel 113 by the image processing apparatus 100 will be described in detail with reference to FIG. 4C and subsequent drawings.

First, the user selects (touches) the icon 402 on the home screen illustrated in FIG. 4A to activate the ID card copy function. This results in the screen illustrated in FIG. 4C being displayed on the operation panel 113.

An image 406, a size of paper on which print is executed, a color setting, and the like are displayed on this screen. The image 406 is an image indicating how to print the front side and the back side of the ID card, and is an image illustrating its layout. When the user touches the image 406, a layout selection screen illustrated in FIG. 4D is displayed on the operation panel 113.

FIG. 4D illustrates a screen for selecting a layout setting. There is a plurality of types of layouts that can be printed with the ID card copy function as illustrated in, for example, FIG. 4D. It is possible for the user to select and set a layout that the user wants to copy. When the user selects a setting, the CPU 101 accepts the setting (setting value), and stores the setting in the setting unit 303 (a storage medium such as the flash ROM 104). Specifically, regarding a layout setting item "layout", a setting value of any one of "full", "half", and "halfLR" is set and stored.

In a case where the user uses the ID card copy function for the first time, "full" is stored as a default setting value, for example. In a case where the procedure manual is created and printed at this time point, an image of IDcopy_layout_full.jpg is used. In a case where the user has used the ID card copy function before, a setting value used at the time of previous execution of the function by the image processing apparatus 100 is stored.

For example, in a case where the user changes the layout setting to "half" and then uses the ID card copy function, the layout setting selected by the user is stored. When the procedure manual is created and printed, an image of IDcopy_layout_half.jpg is used. In this manner, the procedure manual is printed based on the stored setting. That is, the image processing apparatus 100 prints a procedure manual having a pattern of each layout setting depending on the user's selection.

An image 406 to be displayed on the screen illustrated in FIG. 4C is displayed to have a layout set in FIG. 4D. That is, the screen illustrated in FIG. 4C changes depending on the ID card copy layout setting.

When the user touches a copy button on the screen illustrated in FIG. 4C, a screen illustrated in FIG. 4E is displayed on the operation panel 113. This screen instructs the user about a method of placing the ID card on the scanner 111 in the image processing apparatus 100. An image 408 on a dialog screen 407 instructs an orientation on how to place the ID card. FIG. 4E illustrates a state where the screen instructs the user to place the ID card in a vertical orientation. In some image processing apparatuses 100, the orientation of the ID card to be placed on the scanner 111 at the time of scanning needs to be changed depending on the layout selected (set) by the user in FIG. 4D.

When the user touches a next button on the screen illustrated in FIG. 4E, the CPU 101 controls the scanner 111 to execute scan of the placed ID card. A screen illustrated in FIG. 4G is then displayed on the operation panel 113. Th screen illustrated in FIG. 4G indicates that the image processing apparatus 100 is executing processing of scanning the ID card (document) placed on the scanner 111. When the scan processing ends, a screen illustrated in FIG. 4F is displayed on the operation panel 113.

The screen illustrated in FIG. 4F instructs the user to turn the ID card over and place the ID card on the scanner 111. When the user touches the next button on the screen of FIG. 4F, the screen illustrated in FIG. 4G and indicating that scan is in execution is displayed again on the operation panel 113. When the execution of the scan processing ends, the print processing is subsequently executed, and a sheet on which the front surface and back surface of the ID card has been printed according to the layout set in FIG. 4D is discharged from the image processing apparatus 100.

The description has been given of the example of the screen displayed on the operation panel 113 when the image processing apparatus 100 executes the ID card copy function. The user performs an operation according to instructions displayed on these screens, and can thereby copies the ID card.

Since some image processing apparatuses at a low price have small displays (e.g., operation panel 113) for displaying a screen, the screen being displayed is also small. This can make it difficult for the user to see an instruction for using a function of the image processing apparatus. A small display can cause poor visibility of, for example, the image 408 illustrated in FIG. 4E, which instructs the user to place the ID card in the vertical orientation. Thus, a possibility exists that a user operation fails.

In a case where a screen to be displayed changes depending on a setting like the image 406 illustrated in FIG. 4C, a screen that reflects the setting should also be displayed in a procedure manual to be printed.

In view of this, a method of creating print data by referring to a setting of the image processing apparatus 100 will be described with respect to the first embodiment.

FIGS. 8A to 8D each illustrate an example of a setting screen displayed on the operation panel 113 in the image processing apparatus 100 according to the first embodiment. When the user touches the icon 405 for setting functions on the screen illustrated in FIG. 4B, a screen including a list of setting items illustrated in FIG. 8A is displayed on the operation panel 113. When the user touches a "PRINT OPERATION PROCEDURE" button 801 on the screen illustrated in FIG. 8A, a screen including a list of operation types illustrated in FIG. 8B is displayed on the operation panel 113.

When the user touches a "PRINT ID CARD COPY OPERATION PROCEDURE" button 851 on the screen illustrated in FIG. 8B, the CPU 101 of the image processing apparatus 100 starts processing of creating print data for the procedure manual.

When the user touches a "PRINT COPY OPERATION PROCEDURE" button 852, the CPU 101 of the image processing apparatus 100 starts processing of creating print data for the procedure manual. The user's selection of a predetermined button like the above-described buttons is an instruction for execution of the processing of printing the procedure manual. When the CPU 101 accepts the instruction for execution, the procedure manual corresponding to the instruction (button) is printed.

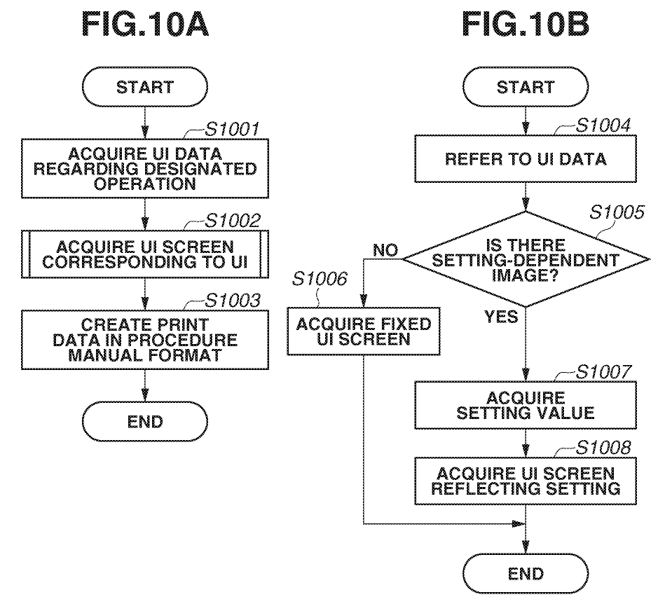

FIGS. 10A and 10B are flowcharts illustrating examples of processing executed by the CPU 101 of the image processing apparatus 100 according to the first embodiment to create print data for the procedure manual that describes the operation procedure. FIG. 10A illustrates the flow of the entire processing, while FIG. 10B illustrates details of the processing in step S1002.

When the user touches the "PRINT ID CARD COPY OPERATION PROCEDURE" button 851 on the screen illustrated in FIG. 8B, the CPU 101 starts processing of creating print data for the procedure manual. The button for printing the procedure manual is not limited to the "PRINT ID CARD COPY OPERATION PROCEDURE" button 851, and the user can designate a function for which to print a procedure manual from among buttons (not illustrated) for printing operation procedures for various functions executable by the image processing apparatus 100.

Turning to FIG. 10A, in step S1001, the CPU 101 of the image processing apparatus 100 acquires UI data regarding a designated operation from the UI management unit 302. The designated operation is an operation to execute the copy function or the ID card copy function as illustrated in FIG. 8B.

The UI data is resource data for displaying the screens exemplified in FIGS. 4A, 4C, 4E, 4F, and 4G on the operation panel 113. The resource is, for example, a HyperText Markup Language (HTML) file, a Cascading Style Sheet (CSS) file, or a Joint Photographic Experts Group (JPG) file, but a format is not limited thereto. In a case where a UI screen is displayed by a program that generates a screen with a setting and parameter of the main apparatus as arguments, the resource may be these arguments and the program.

Next, in step S1002, the CPU 101 acquires a UI screen (image) from the UI data.

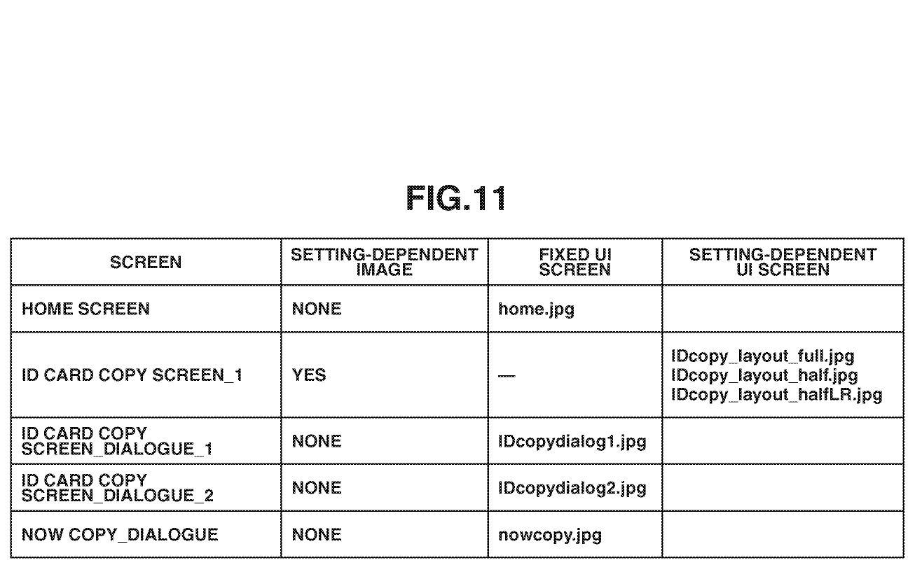

Details of the processing in step S1002 will now be described with reference to FIG. 10B. Assume that the UI management unit 302 manages a database as illustrated in FIG. 11.

The database illustrated in FIG. 11 stores information regarding screens to be displayed on the operation panel 113 when the user uses various functions executable by the image processing apparatus 100 and various types of information associated with the information regarding the screens. Examples of various types of information include a setting-dependent screen, a fixed UI screen, and a setting-dependent UI screen. In a case of a setting-dependent screen, information regarding the setting-dependent UI screen is stored. In a case where there is no setting-dependent screen, information regarding the fixed UI screen is stored in association with corresponding screen information. The setting-dependent screen is, for example, the screen illustrated in FIG. 4C described above.

Details of the processing in step S1002 will now be described with reference to FIG. 10B.

First, in step S1004, the UI management unit 302 controlled by the CPU 101 refers to the database illustrated in FIG. 11, and acquires the UI data corresponding to the function designated by the user. In step S1005, the CPU 101 determines whether a setting-dependent image (screen) is included in the screen displayed for executing the function using the acquired UI data. For example, UI data regarding "ID card copy screen_1" includes the setting-dependent image as illustrated in FIG. 11.

In a case where the CPU 101 determines that the setting-dependent image is not included as a result of the processing in step S1005 (NO in step S1005), the processing proceeds to step S1006. In step S1006, the CPU 101 acquires the fixed UI screen. For example, if the UI data is data regarding the home screen, the CPU 101 can confirm that there is no setting-dependent image from the data in FIG. 11, and acquires "home.jpg", which is the fixed UI screen.

In a case where the CPU 101 determines that a setting-dependent image is included as a result of the processing in step S1005 (YES in step S1005), the processing proceeds to step S1007. In step S1007, the CPU 101 acquires a setting value from the setting unit 303. In step S1008, the CPU 101 then acquires a UI screen that reflects the setting.

A simple method for the CPU 101 to identify a setting value and an image corresponding to the setting value is to include the setting value in a file name of the image. For example, a text string including the name of a screen, a setting item, and the setting value which are separated by underscores can serve as a file name. In this example, the name of the screen is "IDcopy" and the setting item is "layout".

In the present embodiment, any one of three setting values is set as the setting item "layout" on the screen illustrated in FIG. 4D. Specifically, the setting value is "full", "half", or "halfLR". In the example illustrated in FIG. 11, three image files of "IDcopy_layout_full.jpg", "IDcopy_layout_half.jpg", and "IDcopy_layout_halfLR.jpg" correspond to the setting values.

"IDcopy_layout_full.jpg" corresponds to a full page layout image on the left side in FIG. 4D. "IDcopy_layout_half.jpg" corresponds to a half page layout image in the middle in FIG. 4D. "IDcopy_layout_halfLR.jpg" corresponds to a half page left-right layout image on the right side in FIG. 4D.

Returning to FIG. 10B, in step S1008, the CPU 101 selects the setting-dependent UI screen from the image of "IDcopy_layout_full.jpg", the image of "IDcopy_layout_half.jpg", and the image of "IDcopy_layout_halfLR.jpg", and acquires the UI screen. Specifically, if the setting value of the setting item "layout" is "full", the CPU 101 acquires "IDcopy_layout_full.jpg".

In step S1003, the CPU 101 creates print data in a procedure manual format. For example, the image processing apparatus 100 may have a configuration in which a text template indicating each operation procedure for the present function is preliminarily stored in the flash ROM 104 or a storage device with which the image processing apparatus 100 is communicable. In this case, the CPU 101 acquires the text template, inserts the UI screen (image) acquired in step S1006 or S1008 into the text template, and can thereby create print data in the procedure manual format.

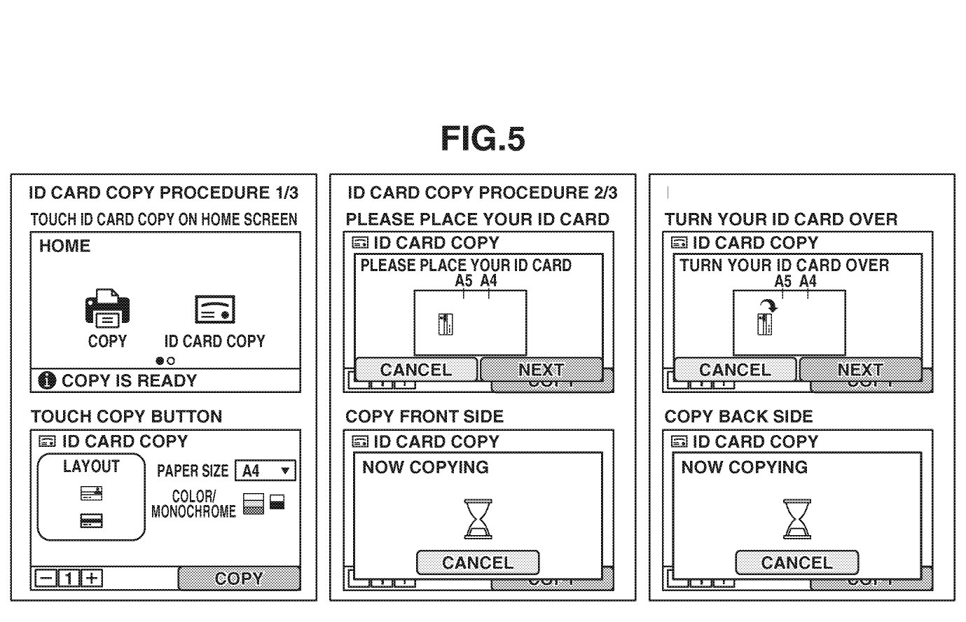

FIG. 5 illustrates an example in which the print data created by the CPU 101 in step S1003 is printed on a sheet (print medium). Texts indicating the operation procedure and the operation screen are printed on sheets, and thus are larger than those displayed on a small screen and easily visible to the user. For example, presenting the printed procedure manual near the image processing apparatus 100 enables the user to make various kinds of settings even if the image processing apparatus 100 has a small screen.

The procedure manual is an example of a document describing the method of operating the image processing apparatus 100. The document includes an image illustrating a screen corresponding to the layout setting accepted by the user's selection and the description of the method of operating the image processing apparatus 100 to execute the ID card copy function. The operation method is described using the image illustrating the screen and texts (text strings) as illustrated in FIG. 5.

To simplify the description, there is no setting-dependent image on the home screen in FIG. 11. However, typically, a language displayed on the home screen may change depending on a set language of the image processing apparatus 100. Thus, the image on the home screen is not limited to "home.jpg", and may be handled as the setting-dependent UI screen such as "home_en.jpg", "home_jp.jpg", or "home_ch.jpg".

The above-described first embodiment has discussed the method of creating print data by referring to the setting.

### Second Embodiment

In the first embodiment, a function for which the procedure manual is to be printed is selected from the setting menu. A scene where the user typically requires the procedure manual is when the image processing apparatus 100 displays a screen for some kind of function in many cases.

A second embodiment provides a method of creating print data for a procedure manual for a function regarding a screen being displayed by the image processing apparatus 100.

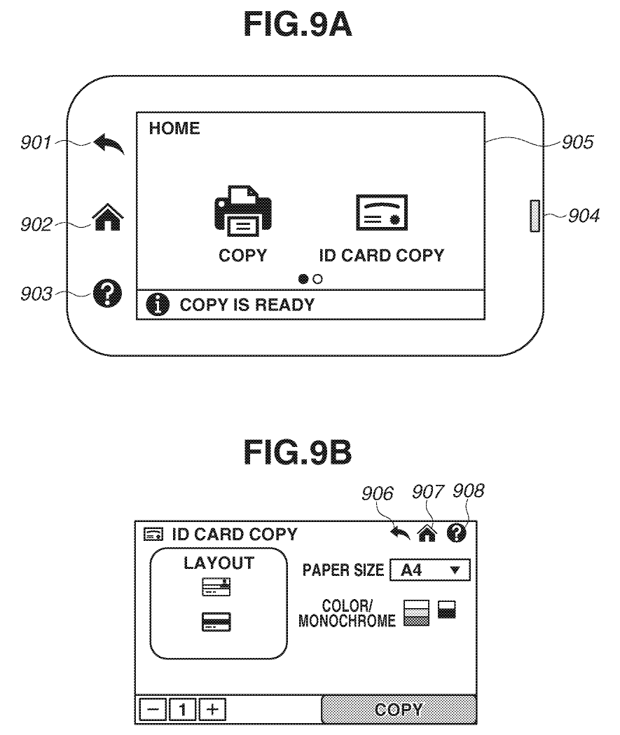

FIGS. 9A and 9B illustrate the operation panel 113 in the image processing apparatus 100 according to the second embodiment and an example of a screen to be displayed, respectively. FIG. 9A is a schematic view of the operation panel 113. A screen 905 is displayed in a display portion in a middle of the operation panel 113. A back button 901, a home button 902, and a help button 903 are disposed at an edge of the operation panel 113. A light emitting diode (LED) 904 indicating a power state is disposed on an opposite edge of the operation panel 113. The example illustrated in FIG. 9A has a configuration in which functions frequently used by the user can be accessed any time as buttons.

FIG. 9B illustrates an example of a screen display. In this example, instead of the buttons, icons for executing functions corresponding to the respective buttons described above are displayed at the edge of the screen at all times. A back icon 906, a home icon 907, a help icon 908 are displayed at the upper right corner of the screen illustrated in FIG. 9B.

In a case where the user wants to print a procedure manual in the configuration illustrated in FIG. 9A or the configuration in FIG. 9B, the user selects the help button 903 or the help icon 908. When the selection is detected, the image processing apparatus 100 displays help information (not illustrated) and a menu for printing the operation procedure as illustrated in FIG. 8B. That is, the user selects the help button 903 or the help icon 908, and can thereby instruct execution of processing of printing the procedure manual.

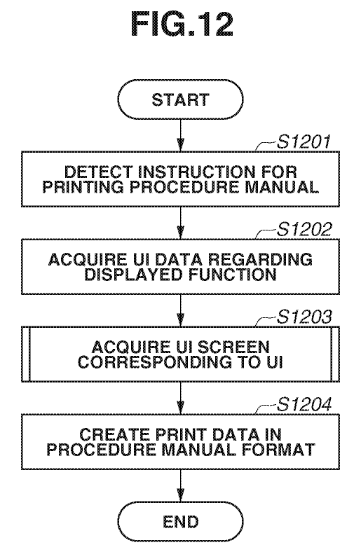

FIG. 12 is a flowchart illustrating an example of processing executed by the CPU 101 of the image processing apparatus 100 according to the second embodiment to create print data for the procedure manual that describes the operation procedure. The processing starts at a timing, for example at the time of power-ON of the image processing apparatus 100, when the function of the help button 903 or the help icon 908 is enabled.

In step S1201, the CPU 101 of the image processing apparatus 100 detects the instruction for printing the procedure manual in response to the selection of the help button 903 or the help icon 908. Then, in step S1202, the CPU 101 acquires UI data regarding a function displayed on the operation panel 113, similar to step S1001. Next, in step S1203, the CPU 101 acquires a UI screen corresponding to the UI, similar to step S1002. In step S1204, the CPU 101 then creates print data in the procedure manual format, similar to step S1003.

When the UI screen corresponding to the function is displayed on the operation panel 113 in the image processing apparatus 100 as a result of the above-mentioned processing, print data of the procedure manual for the function regarding the displayed screen is created. This enables the user to print the procedure manual.

### Third Embodiment

In the first embodiment, the example of printing the procedure manual described in only a single language (English) has been described (FIG. 5). However, since there is a possibility that the image processing apparatus 100 is used by an unspecified number of people, it is favorable that the procedure manual be described in a plurality of languages. While it is difficult for a small-sized display to simultaneously display the plurality of languages, the procedure manual printed on large-sized sheet enables easy presentation of explanations in the plurality of languages in a mixed manner. This makes it possible to enhance the effects of the present disclosure.

A third embodiment provides a method of printing a procedure manual corresponding to a plurality of languages.

The first embodiment described an example where each print button illustrated in FIG. 8B is selected, enabling the procedure manual corresponding to each print button to be immediately printed. In the third embodiment, when the "PRINT ID CARD COPY OPERATION PROCEDURE" button 851 illustrated in FIG. 8B is pressed, a details setting screen for setting details of the procedure manual illustrated in FIG. 8C is displayed on the operation panel 113.

The details setting screen illustrated in FIG. 8C displays, a region 802 for selecting a plurality of languages to be used in explanatory texts in the procedure manual. The user can select (designate) languages which the user wants to use in the explanation of the procedure manual from among languages displayed in the region 802.

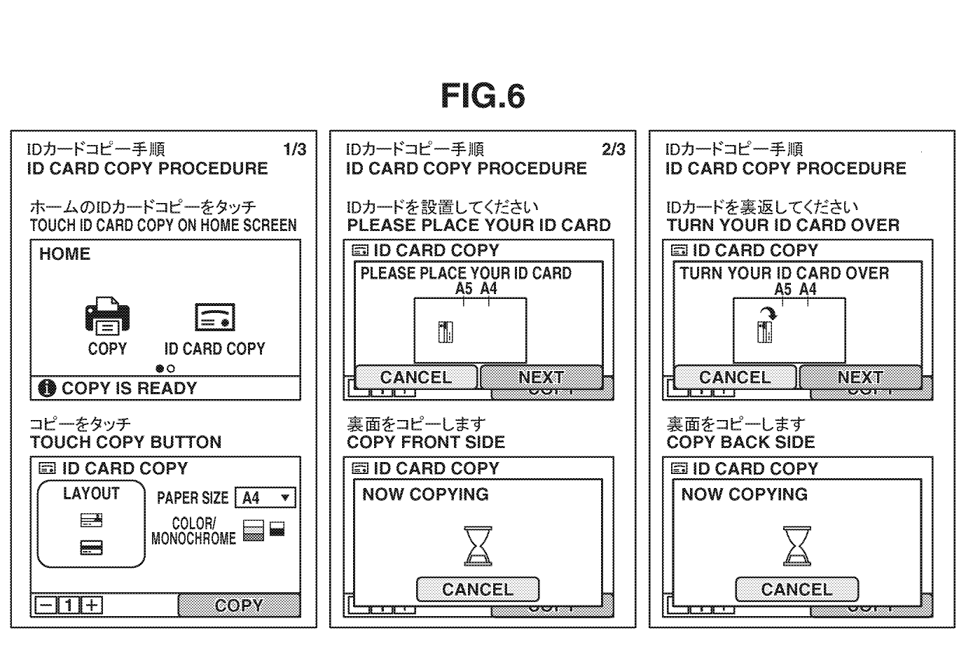

In a case where a plurality of languages is selected in the region 802, a region 803 is displayed for selecting whether these languages are to be included in one copy of a print product in a mixed manner or a plurality of copies of the procedure manual in respective languages are to be printed. In a case where the user selects a setting to include all languages in one copy of the print product in the region 803, a print product as illustrated in FIG. 6 printed.

A region 804, described below, is also displayed on the details screen.

The CPU 101 of the image processing apparatus 100 starts processing of creating and printing the procedure manual when the print button on the details screen illustrated in FIG. 8C is pressed. In the example of displaying the screen, selecting the print button on this screen enables the user to instruct execution of the print processing.

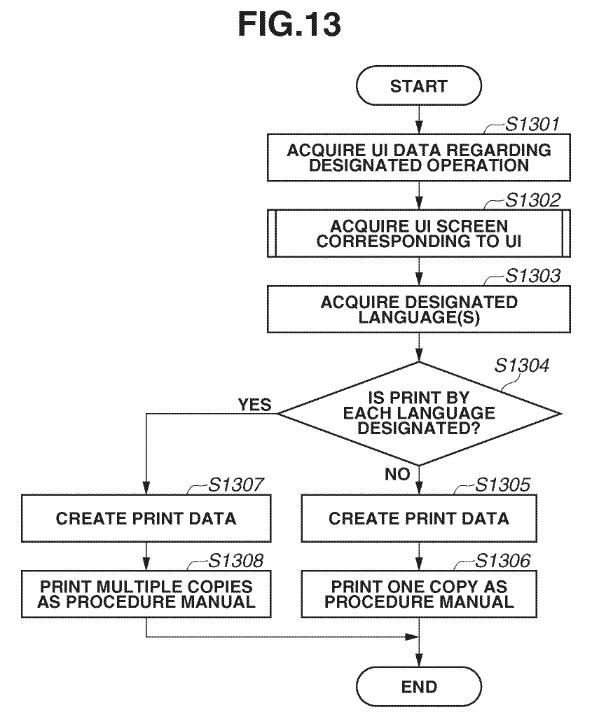

FIG. 13 is a flowchart illustrating an example of processing executed by the image processing apparatus 100 according to the third embodiment to create print data for the procedure manual that describes the operation procedure.

First, in step S1301, the CPU 101 of the image processing apparatus 100 acquires UI data regarding a designated operation, similar to step S1001. Then, in step S1302, the CPU 101 acquires a UI screen corresponding to the UI, similar to step S1002. Next, in step S1303, the CPU 101 acquires the language(s) designated in the region 802 illustrated in FIG. 8C. In step S1304, the CPU 101 determines whether print by each language is designated in the region 803.

In a case where the CPU 101 determines that print by each language is not designated as a result of the processing in step S1304 (NO in step S1304), the processing proceeds to step S1305. In step S1305, the CPU 101 uses texts in all the designated languages to create print data. Then, in step S1306, the CPU 101 controls the printer 112 to print one copy of the procedure manual. Explanations described in all the languages selected by the user on the details screen are provided on the print product. FIG. 6 illustrates an example of the procedure manual printed in step S1306.

In a case where the CPU 101 determines that print by each language is designated as a result of the processing in step S1304 (YES in step S1304), the processing proceeds to step S1307. In step S1307, the CPU 101 creates print data for the procedure manual that describes explanations in respective designated languages. Next, in step S1308, the CPU 101 prints the procedure manual described in respective languages in the number of copies corresponding to the number of designated languages. In the present example, one copy of the procedure manual described in English in FIG. 5 and one copy of a Japanese version of the procedure manual are printed as the procedure manual printed in step S1308.

The above-mentioned processing makes it possible to print the procedure manual corresponding to a plurality of languages.

### Fourth Embodiment

A fourth embodiment will describe a method of adding a highlighting effect to an image in the procedure manual. Highlighting effects make it easier for the user who does not understand a language described in the procedure manual to grasp what operation should be performed when looking at the procedure manual.

In the fourth embodiment, the region 804 for selecting whether to highlight a button or the like on an operation screen printed on the procedure manual is displayed on the details screen illustrated in FIG. 8C. That is, highlighting a part to which the user should pay attention (an object or a region that should be operated next) in the image illustrating the screen described in the procedure manual to be printed makes it easier for the user to understand an operation to be performed next.

In the present embodiment, the user checks a check box displayed in the region 804, and can thereby make a setting to perform print by highlighting a button that should be selected next in the procedure manual to be printed.

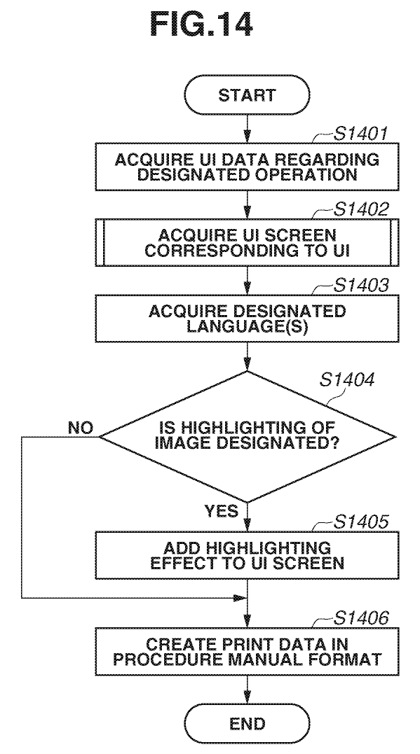

FIG. 14 is a flowchart illustrating an example of processing executed by the CPU 101 of the image processing apparatus 100 according to the fourth embodiment to create print data for the procedure manual that describes the operation procedure. The present processing starts when the print button on the details screen illustrated in FIG. 8C is selected.

First, in step S1401, the CPU 101 of the image processing apparatus 100 acquires UI data regarding a designated operation, similar to step S1001. Then, in step S1402, the CPU 101 acquires a UI screen corresponding to the UI, similar to step S1002. Next, in step S1403, the CPU 101 acquires the language(s) designated in the region 802 on the details screen in FIG. 8C. In step S1404, the CPU 101 determines whether a highlight setting is designated in the region 804 (whether the check box is checked).

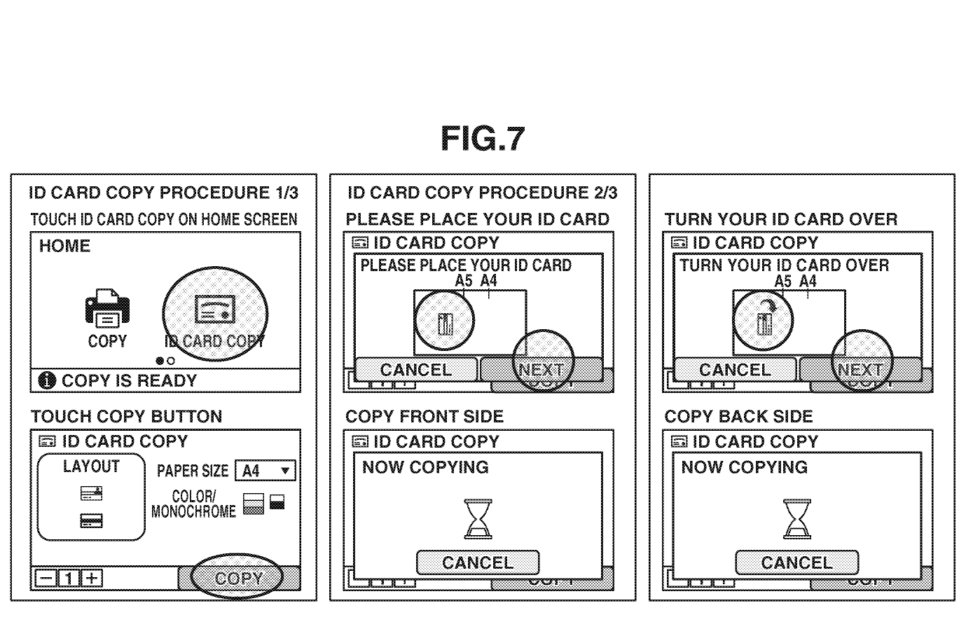

In a case where the CPU 101 determines that the highlight setting is designated as a result of step S1404 (YES in step S1404), the processing proceeds to step S1405. In step S1405, the CPU 101 adds a highlighting effect to the UI screen. For example, the UI management unit 302 is configured to store, as data, a button to be pressed for each operation and a display region to which attention should be paid together with a text template, and the CPU 101 refers to these pieces of data and can thereby color these regions. For example, by allocating an identification number to each object or each region to be displayed on the screen, these objects and the content of the text template match. In step S1406, the CPU 101 then creates print data for the procedure manual. FIG. 7 illustrates an example of the procedure manual to be printed in a case where the highlighting is designated.

The above-mentioned processing enables highlighting a button and a region that should be operated by the user, whereby the procedure manual that can help understanding of the user who cannot read the language displayed on the operation panel 113 is printed.

### Fifth Embodiment

The first embodiment provided a description of the method in which the CPU 101 of the image processing apparatus 100 refers to the stored current setting when the user selects the button for printing the operation procedure in FIG. 8B and prints the procedure manual using an image corresponding to the setting. In the first embodiment, in a case where the user wants to print the procedure manual including an image corresponding to a target layout setting, the ID card copy function is used once to change a setting value.

At the time of printing the procedure manual, there is a use case where the user wants to print the procedure manual using an image corresponding to a setting different from a current setting without changing the setting. A fifth embodiment provides a description of a method for selecting a target setting enabling the user to designate an image to be used in the procedure manual when an instruction for printing the procedure manual is provided.

In the fifth embodiment, when "PRINT ID CARD COPY OPERATION PROCEDURE" button 851 in FIG. 8B is pressed, the CPU 101 of the image processing apparatus 100 displays a selection screen for selecting a setting item as illustrated in FIG. 8D on the operation panel 113. As described above, the user selects a setting on the selection screen, whereby the image processing apparatus 100 prints the procedure manual using the image corresponding to the selected setting.

In the example of the selection screen in FIG. 8D, radio buttons for the user to designate a setting value are displayed. The user selects a radio button, and can thereby select a layout, which is a setting item corresponding to the image displayed on the operation screen for the ID card copy function (FIG. 4C). That is, the user selects, on the selection screen, an image that the user wants to print on the procedure manual and that corresponds to the setting.

The CPU 101 may be configured to store the setting value corresponding to the radio button selected by the user in the setting unit 303.

When the user selects the print button illustrated in FIG. 8D, the CPU 101 of the image processing apparatus 100 creates the print data for the procedure manual, similar to when the print button on the screen in FIG. 8C is selected in the first embodiment. The procedure manual is then printed using this print data. That is, in the example of displaying the screen, selecting the print button on this screen enables the user to instruct execution of the print processing.

In step S1008 in the first embodiment, the CPU 101 acquires the setting value from the setting unit 303. In step S1008 in the fifth embodiment, the CPU 101 acquires the setting value corresponding to the radio button selected by the user in FIG. 8D.

The CPU 101 may have, for example, a configuration enabling the user to set both a language of the procedure manual as set in FIG. 8C and a layout as set in FIG. 8D as a combination with the above-mentioned first to fourth embodiments.

As described above, it is possible for the user to cause the image processing apparatus 100 to print the procedure manual using an image corresponding to a freely determined setting without changing a setting.

### Other Embodiments

While details of the embodiments have been described above, the present disclosure can be implemented as embodiments as a system, an apparatus, a method, a program, a recording medium (storage medium), or the like. Specifically, the present disclosure may be applied to a system composed of a plurality of devices (for example, a host computer, an interface device, an imaging apparatus, and a web application) or an apparatus composed of one device.

A recording medium (or a storage medium) that records program codes (computer program) of software that implements functions of the above-mentioned embodiments is supplied to a system or an apparatus. The storage medium mentioned herein is, a computer-readable storage medium.

A computer (or a CPU or a microprocessing unit (MPU)) of the system or the apparatus reads out the program codes stored in the recording medium and executes the program codes. In this case, the program codes, which are read out from the recording medium, implement the above-mentioned functions according to the embodiments, and the recording medium that stores the control program codes constitutes the present disclosure.

The present disclosure can also be implemented by supplying a program that implements one or more functions of the above-mentioned embodiments to a system or an apparatus via a network or a storage medium, and reading and executing the program by one or more processors in the computer of the system or the apparatus. The present disclosure can also be implemented by a circuit (for example, an ASIC) that implements one or more functions.

According to the present disclosure, a procedure manual enabling the user to easily understand an operation is created.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-022439, filed February 14, 2025, which is hereby incorporated by reference herein in its entirety.

What is claimed is:

1. An image forming apparatus comprising:
at least one memory that stores a set of instructions for executing a function;
at least one controller configured to execute the instructions to cause the image forming apparatus to:
accept a setting regarding the function; and
display a screen corresponding to the accepted setting; and
a printer configured to print a document including an image illustrating the screen corresponding to the accepted setting and a method of operating the image forming apparatus to execute the instructions.

2. The image forming apparatus according to claim 1,
wherein the at least one controller is further configured to execute the instructions to cause the image forming apparatus to accept an instruction for execution of print, and
wherein the printer is further configured to execute print of the document in response to acceptance of the instruction for execution.

3. The image forming apparatus according to claim 2, wherein the at least one controller is further configured to execute the instructions to cause the image forming apparatus to accept the instruction for execution in response to selection of a predetermined object.

4. The image forming apparatus according to claim 1, wherein the printer is further configured to print a document including an image illustrating a screen corresponding to a setting accepted at a time of previous execution of the function by the image forming apparatus and the method of operating the image forming apparatus to execute the function.

5. The image forming apparatus according to claim 1,
wherein the at least one controller is further configured to execute the instructions to cause the image forming apparatus to accept a language to describe the method of operating the image forming apparatus to execute the function in the document, and
wherein the printer is further configured to print a document including the method of operating the image forming apparatus to execute the function, the method being described in the accepted language, and the image illustrating the screen corresponding to the accepted setting.

6. The image forming apparatus according to claim 5,
wherein the at least one controller is further configured to execute the instructions to cause the image forming apparatus to accept a plurality of languages, and
wherein the printer is further configured to print a document including the method of operating the image forming apparatus to execute the function, the method being described in the plurality of accepted languages, and the image illustrating the screen corresponding to the accepted setting.

7. The image forming apparatus according to claim 1, wherein the document is printed so that, in the image illustrating the screen corresponding to the accepted setting, a part to which a user should pay attention to is highlighted.

8. The image forming apparatus according to claim 1, wherein the function is a card copy function.

9. The image forming apparatus according to claim 1, wherein the printer is further configured to print the document on a print medium.

10. A method of controlling an image forming apparatus, the method comprising:
executing a function;
accepting a setting regarding the function;
displaying a screen for executing the function, the screen corresponding to the accepted setting; and
printing a document including an image illustrating the screen corresponding to the accepted setting and a method of operating the image forming apparatus to execute the function.

11. The method of controlling the image forming apparatus according to claim 10,
wherein the accepting further includes accepting an instruction for execution of print,
wherein the printing includes executing print of the document in response to acceptance of the instruction for execution.

12. The method of controlling the image forming apparatus according to claim 11, wherein the accepting includes accepting the instruction for execution in response to selection of a predetermined object.

13. The method of controlling the image forming apparatus according to claim 10, wherein the printing includes printing a document including an image illustrating a screen corresponding to a setting accepted at a time of previous execution of the function by the image forming apparatus and the method of operating the image forming apparatus to execute the function.

14. The method of controlling the image forming apparatus according to claim 10,
wherein the accepting further includes accepting a language to describe the method of operating the image forming apparatus to execute the function in the document, and
wherein the printing includes printing a document including the method of operating the image forming apparatus to execute the function, the method being described in the accepted language, and the image illustrating the screen corresponding to the accepted setting.

15. The method of controlling the image forming apparatus according to claim 14,
wherein the accepting includes accepting a plurality of languages, and
wherein the printing includes printing a document including the method of operating the image forming apparatus to execute the function, the method being described in the plurality of accepted languages, and the image illustrating the screen corresponding to the accepted setting.

16. The method of controlling the image forming apparatus according to claim 10, wherein the document is printed so that, in the image illustrating the screen corresponding to the accepted setting, a part to which a user should pay attention to is highlighted.

17. The method of controlling the image forming apparatus according to claim 10, wherein the function is a card copy function.

18. The method of controlling the image forming apparatus according to claim 10, wherein the printing includes printing the document on a print medium.

19. A computer-readable storage medium storing a program for causing an image forming apparatus to execute the method of claim 10.
